(19) United States
(12) Patent Application Publication
(10) Pub. No.: US 2024/0182612 A1
(43) Pub. Date: Jun. 6, 2024

(54) METHOD FOR PRODUCING ETHYLENE POLYMER PREDICTING AND CONTROLLING THE DENSITY OF ETHYLENE POLYMER IN REAL TIME USING ON-LINE ANALYZER

(71) Applicant: SABIC SK NEXLENE COMPANY PTE. LTD., Singapore (SG)

(72) Inventors: Dae Ho Shin, Daejeon (KR); Choon Sik Shim, Sejong (KR); Dong Hun Kwak, Daejeon (KR); Dong Kyu Park, Daejeon (KR)

(21) Appl. No.: 18/556,644

(22) PCT Filed: May 27, 2022
(86) PCT No.: PCT/IB2022/054990

§ 371 Date: Oct. 20, 2023

(30) Foreign Application Priority Data
Jun. 1, 2021 (KR) 10-2021-0070568

(51) Int. Cl. C08F 210/16; C08F 2/01; C08F 2/06; G01N 21/65

(52) U.S. Cl. CPC C08F 210/16; C08F 2/01; C08F 2/06; G01N 21/65

(57) ABSTRACT

The present invention relates to a method for producing ethylene polymer predicting and controlling the density of ethylene polymer in real time using on-ling analyzer. Specifically, the present invention relates to a method for producing a polymer having a desired property by measuring properties such as the density of a polymer and a content of unreacted substances in real time on-line in a polymerization reactor system and controlling a content of raw materials injected into polymerization therefrom.

### TECHNICAL FIELD

The following disclosure relates to a method for producing ethylene polymer predicting and controlling the density of ethylene polymer in real time using on-ling analyzer. Specifically, the following disclosure relates to a method for producing a polymer having a desired property by measuring the properties such as the density of a polymer and a content of unreacted substances in real time on-line in a polymerization reactor system and controlling the content of raw materials injected for polymerization therefrom.

### BACKGROUND ART

An ethylene polymer is produced by solution polymerization of ethylene and an alpha-olefin comonomer, and the density of a finally obtained polymer is controlled by controlling the content of the alpha-olefin comonomer. In order to further improve productivity, the polymer and unreacted material contained in reactants discharged from a reactor are separated, and the unreacted material, that is, unreacted alpha-olefin comonomer is re-injected as a raw material for reuse.

In order to accurately measure a density of a finally prepared product in a producing process of such an ethylene polymer, the finally prepared product in the form of pellets was measured according to ASTM D792 after synthesis in a state where both injection of raw materials and a polymerization process were constantly fixed.

However, when the density of the final product is measured in this way, it is necessary to perform reaction, separation and pelletization processes for 4 to 5 hours before the final product is prepared, and if the product is not prepared to the desired density by performing analysis of the prepared pellet, it is necessary to control a flow rate of the raw material again based on this result to perform polymerization. Thus, it is difficult to produce a product of the desired density.

In addition, since it is impossible to analyze a material having a too high boiling point and a polymer with gas chromatography, analysis of a rear end of the reactor containing the polymer is not possible. Thus, it is difficult to control a density of a final product by controlling a flow rate of a raw material in real time using gas chromatography.

In order to improve this problem, it was attempted to control a content of a material injected as a raw material by analyzing the content of a recycle material using gas chromatography from a front end of the reactor. However, when a recycle stream containing isomers, etc. is analyzed by gas chromatography, a peak overlap occurs between the material having a boiling point similar to that of the unreacted alpha-olefin comonomer to be used as a reaction raw material and an unreacted alpha-olefin comonomer. Thus, it is impossible to accurately quantify only the unreacted alpha-olefin comonomer, so it is difficult to accurately control the content of the unreacted alpha-olefin comonomer flowing into the reactor from the unreacted material, and it is difficult to control the density of the final product.

In addition, peak separation of the isomers by gas chromatography takes about 3 hours, and it takes a lot of time to analyze the isomers accurately, so real time polymerization reactions could not be controlled.

### DISCLOSURE OF INVENTION

### Technical Problem

An embodiment of the present invention is directed to providing a method for producing an ethylene copolymer having a constant quality by controlling the content of the injected material, etc. to control the density of the ethylene copolymer in real time, or by calculating density of a product at a rear end of the reactor in real time, by quantitatively analyzing the content of an unreacted alpha-olefin comonomer using a spectrometer in a polymerization process of the ethylene polymer.

That is, an embodiment of the present invention is to provide a method capable of controlling the properties of a polymer in a polymerization reaction system in real time.

For this purpose, an embodiment of the present invention is directed to providing a method for producing an ethylene polymer that obtains a predictive model (including component loading and component content of the target material to be measured) for determining properties of a polymer, calculates the components and content from a Raman spectrum measured by a Raman spectrometer in the polymerization process for the predictive model, calculates the density of a final product by applying a value calculated from the Raman spectrum to the predictive model, and then controls polymerization parameters based on the calculated polymer properties.

### Solution to Problem

In one general aspect, there is provided a method for producing an ethylene polymer, the method includes: performing polymerization by injecting ethylene and C₄-C₁₀ alpha-olefin as a first reaction raw material into a first reactor; performing polymerization by injecting a polymerization solution polymerized in the first reactor and ethylene and C₄-C₁₀ alpha-olefin as a second reaction raw material into a second reactor; separating an ethylene polymer and an unreacted material by transferring the polymerization solution polymerized in the second reactor to a separation area; recycling unreacted alpha-olefin and unreacted ethylene by transferring the unreacted material to a recycle area; and re-injecting a recycle stream including the recycled unreacted alpha-olefin and unreacted ethylene into the first and second reactors, wherein a first Raman spectrometer is located at a front end of the first reactor, a second Raman spectrometer is located at a front end of the second reactor, a third Raman spectrometer is located at a rear end of the first reactor, and a fourth Raman spectrometer is located at a rear end of the second reactor, and the density of the ethylene polymer is predicted and controlled by quantitatively analyzing a content of unreacted alpha-olefin in the recycle stream in real time using the first Raman spectrometer and the second Raman spectrometer, quantitatively analyzing a content of unreacted alpha-olefin and unreacted ethylene in a polymerization solution in real time using the third Raman spectrometer and the fourth Raman spectrometer, and controlling in real time an amount of the injected alpha-olefin as a reaction raw material to the first reactor and the second reactor.

The position in the front end means that the Raman spectrometer is located in each of the recycle stream injected into the first reactor and the second reactor.

As such, the degree of polymerization may be determined from an alpha-olefin content of a recycle stream and an alpha-olefin content in a polymerized reactant, and the density may be predicted.

That is, the content of alpha-olefin is determined through Raman analysis, and a regression model for predicting density is made by regressing the content of alpha-olefin and a MI value as variables. Here, the MI value is predicted by making a regression model that predicts the concentration, temperature, alpha-olefin content of the polymer, and the MI value through regression with the MI value, using a viscometer at an outlet of a reactor.

In addition, as in the present invention, the density may be predicted in real time by checking the concentration of alpha-olefin at the front and rear ends of the reactor by measuring the content of alpha-olefin at each location using Raman spectroscopy at four specific points, and adjusting the content of the feed raw material in real time using a difference value therebetween.

That is, since the alpha-olefin content of the recycle stream is directly measured such as the positions of first and second Raman spectrometers, instead of analyzing the inside of the reactor itself, it is possible to provide a method for producing an ethylene polymer capable of simultaneously controlling the flow rate of feed raw materials and controlling the density in real time.

In another general aspect, there is provided a method for producing an ethylene polymer capable of predicting and controlling a melt index (MI) value of the ethylene polymer in real time by further adding a viscometer at the positions of the third Raman spectrometer and the fourth Raman spectrometer, determining a polymer concentration from a viscosity data measured from the viscometer, the content and reaction amount of alpha-olefin being measured in a Raman spectrometer, and correcting a temperature of a reactor.

### Advantageous Effects of Invention

Since the method for producing an ethylene polymer according to the present invention may predict and control the density and melt index of the final polymer in real time, productivity is further improved.

Specifically, in the related art, there are problems in that a lot of time is required in order to analyze the density of the product produced from the reactor and control the reaction, and productivity decreases, such as the need to repeat reproduction several times in order to produce a polymer having the desired physical properties. However, according to the present invention, the physical properties of a finally prepared polymer from the physical properties of each reaction product may be predicted by using Raman spectroscopy, and since the content of the injected raw material may be controlled, analysis, polymerization, and control of the injected amount may be continuously performed without stopping the reaction, thereby further improving productivity.

### BRIEF DESCRIPTION OF DRAWINGS

FIG. 1 is a schematic diagram of a solution polymerization process of an ethylene polymer according to an embodiment of the present invention.

### DETAILED DESCRIPTION OF MAIN ELEMENTS

1: first Raman spectrometer
2: second Raman spectrometer
3: third Raman spectrometer
4: fourth Raman spectrometer
10, 30: ethylene
20, 40: alpha-olefin
100: first reactor
200: second reactor
300: separation area
400: ethylene polymer
500: recycle area
510, 520: recovery stream
600, 700: purifier
800, 900: controller

### BEST MODE FOR CARRYING OUT THE INVENTION

Hereinafter, the present invention will be described in more detail with reference to embodiments and examples including accompanying drawings. The following specific examples and embodiments are only a reference for describing the present invention in detail, and the present invention is not limited thereto, and may be implemented in various forms.

In addition, all technical terms and scientific terms have the same meanings as those commonly understood by a person skilled in the art to which the present invention pertains unless otherwise defined. The terms used in the description of the present invention are only for effectively describing certain embodiments, and are not intended to limit the present invention.

In addition, singular forms used in the detailed description and the claims are intended to include the plural forms unless otherwise indicated in context.

Unless explicitly described otherwise, “including” any component will be understood to imply the inclusion of other components rather than the exclusion of other components.

In the present invention, the term “polymer” refers to a polymerizable compound prepared by polymerizing a monomer. Specifically, the “polymer” includes homopolymers, copolymers, terpolymers, interpolymers, etc. The “interpolymer” refers to a polymer prepared by polymerizing two or more different monomers. Thus, the generic term “interpolymer” includes not only terpolymers but also copolymers. The copolymer refers to a polymer prepared from two different monomers, and a terpolymer refers to a polymer prepared from three different monomers.

An object of the present invention is to provide a method for producing an ethylene polymer that may be controlled in real time to determine the injected amount of a raw material by analyzing and predicting the properties of an ethylene polymer in real time on-line, and to meet the required physical properties. That is, the present invention provides a method for producing an ethylene polymer that may be controlled in real time in a reactor system without requiring separate sample preparation and analysis.

Specifically, a method for producing an ethylene polymer includes: obtaining a regression model for determining properties of an ethylene polymer; calculating scores of major components using Raman spectroscopy simultaneously with polymerization of the ethylene polymer; calculating properties of the polymer by applying the scores to the regression model; and controlling the physical properties of the polymer by controlling a content of a raw material to be injected into the reactor.

More specifically, an aspect of the present invention is a method for producing an ethylene polymer, the method includes: performing polymerization by injecting ethylene and C₄-C₁₀ alpha-olefin as a first reaction raw material into a first reactor; performing polymerization by injecting a polymerization solution polymerized in the first reactor and ethylene and C₄-C₁₀ alpha-olefin as a second reaction raw material into a second reactor; separating an ethylene polymer and an unreacted material by transferring the polymerization solution polymerized in the second reactor to a separation area; recycling unreacted alpha-olefin and unreacted ethylene by transferring the unreacted material to a recycle area; and re-injecting a recycle stream including the recycled unreacted alpha-olefin and unreacted ethylene into the first and second reactors, wherein a first Raman spectrometer is located in a recycle stream of a front end of the first reactor, a second Raman spectrometer is located in a recycle stream of a front end of the second reactor, a third Raman spectrometer is located at a rear end of the first reactor, and a fourth Raman spectrometer is located at a rear end of the second reactor, and the density of the ethylene polymer is predicted and controlled by quantitatively analyzing the content of unreacted alpha-olefin in the recycle stream in real time using the first Raman spectrometer and the second Raman spectrometer, quantitatively analyzing the content of unreacted alpha-olefin and unreacted ethylene in a polymerization solution in real time using the third Raman spectrometer and the fourth Raman spectrometer, and controlling in real time the amount of the injected alpha-olefin as a reaction raw material into the first reactor and the second reactor.

In an aspect, a first reactor for producing a first ethylene polymer and the second reactor for producing a second ethylene polymer may be connected in series or in parallel.

In an aspect, when quantitative analysis is performed in real time using the first to fourth Raman spectrometers, a Raman probe may be inserted in situ.

In an aspect, when quantitative analysis is performed in real time using the first to fourth Raman spectrometers, the method for producing an ethylene polymer may include: obtaining a regression model for determining a density of a polymer; obtaining Raman spectroscopy from the first to fourth Raman spectrometers; calculating scores of major components from the Raman spectroscopy; and calculating the density of the polymer by applying the scores of the main components to the regression model.

In an aspect, the obtaining of the regression model may include: obtaining a content of alpha-olefin through gas chromatography (GC) or NMR analysis by taking each sample at the point where the first to fourth Raman spectrometers are located, obtaining a plurality of spectra using a Raman spectrometer at the same point, and obtaining a plurality of spectra according to the content of the alpha-olefin; and obtaining a density change regression model of the ethylene polymer according to the content of alpha-olefin from the obtained spectrum.

After obtaining the density change regression model of the polymer in this way, in the method for producing an ethylene polymer according to an aspect of the present invention, the amount of polymer produced is calculated by excluding the amount of unreacted ethylene/alpha-olefin at the rear end of the reactor from the total amount of ethylene/alpha-olefin supplied from the front end of the reactor, by obtaining the contents of ethylene and alpha-olefin in the recycle stream and the rear end of the reactor in real time from the first to fourth Raman spectrometers, and applying the contents of ethylene and alpha-olefin to the density change regression model.

In addition, in an aspect of the present invention, the melt index (MI) value may be predicted and adjusted by further adding a viscometer at the positions of the third and fourth Raman spectrometers, the content of reacted alpha-olefin reaction is calculated from the calculated amount of the polymer, and then, the content is corrected with the concentration of the polymer, and also the melt index (MI) value is calculated by correcting a viscosity data at the rear end of the reactor with the reactor temperature. Thereafter, the density change regression model is obtained using the olefin content and the MI value.

In an embodiment, the alpha-olefin may be 1-octene.

In an aspect, from the data of the samples measured by the first and second Raman spectrometers, the content of alpha-olefin, more specifically 1-octene, may be analyzed in real time in peak areas of 3030 to 2826 cm⁻¹ and 1665 to 1624 cm⁻¹ using the regression model obtained by a Partial Least Square (PLS) method, and

From the data of the samples measured by the third and fourth Raman spectrometers, the content of 1-octene may be analyzed using peaks of 3030 to 2826 cm⁻¹ and 1665 to 1624 cm⁻¹ and the content of ethylene may be analyzed in peak areas of 1630 to 1610 cm⁻¹ and 1335 to 1325 cm⁻¹ using the regression model obtained by a Partial Least Square (PLS) method.

In an embodiment, the reaction raw material may further include a solvent and a catalyst.

In an aspect, the ethylene polymer may have an MI of 0.1 to 50 g/10 min.

In an aspect, the ethylene polymer may have a density of 0.85 to 0.95 g/cc.

In an aspect, a melt index (MI) value may be predicted and controlled by further adding a viscometer at the positions of the third and fourth Raman spectrometers.

Hereinafter, the configuration of the present invention will be described in more detail with reference to the drawings.

In an aspect of the present invention, the ethylene polymer may be an ethylene copolymer in which ethylene and a C₄-C₁₀ α-olefin comonomer are polymerized.

More specifically, the α-olefin comonomer may be any one or a mixture of two or more selected from the group consisting of 1-butene, 1-pentene, 4-methyl-1-pentene, 1-hexene, 1-octene, 1-decene, and 1-dodecene. More specifically, the α-olefin comonomer may be any one or a mixture of two or more selected from the group consisting of 1-butene, 1-hexene, 1-heptene, and 1-octene. More preferably, the alpha-olefin may be 1-octene.

The content of the α-olefin comonomer may be controlled and used according to the required physical properties of the polymer.

In an aspect of the present invention, the ethylene polymer may have an MI of 0.1 to 50 g/10 min, and a density of 0.85 to 0.95 g/cc.

In an aspect of the present invention, the ethylene polymer may be polymerized in the presence of a metallocene catalyst. In addition, in addition to the metallocene catalyst, a cocatalyst and a solvent may be further used, if necessary.

The cocatalyst is not limited as long as it is commonly used, and specifically, for example, may be any one or a mixture of two or more selected from a boron compound and an aluminum compound.

The solvent may be a C₃-C₂₀ hydrocarbon, and specifically, for example, may be any one or a mixture of two or more selected from butane, isobutane, pentane, hexane, heptane, octane, isooctane, nonane, decane, dodecane, cyclohexane, methylcyclohexane, benzene, toluene, and xylene.

The ethylene polymer of the present invention may be formed by solution polymerization, and the first reactor for producing the first ethylene polymer and the second reactor for producing the second ethylene polymer may be separately present.

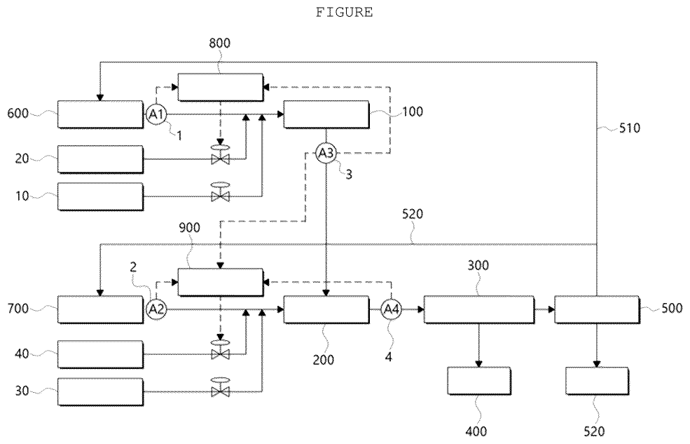

Specifically, as illustrated in FIG. 1, a first reactor (100) and a second reactor (200) may be provided and are connected in series to prepare a first ethylene polymer by injecting ethylene (10) and C₄-C₁₀ alpha-olefin (20) as a first reaction raw material into the first reactor (100), the prepared first ethylene polymer and unreacted material may be continuously transferred to the second reactor (200), ethylene (30), α-olefin comonomer (40), solvent, catalyst, and cocatalyst may be additionally added to the second reactor (200) to polymerize the second ethylene polymer and mix with the first ethylene polymer.

More specifically, an aspect of a method for producing an ethylene polymer mixture of the present invention may include a polymerization step of preparing a first ethylene polymer by polymerizing ethylene and a C₄-C₁₀ α-olefin comonomer in a first reactor in the presence of a first metallocene catalyst and a second ethylene polymer by polymerizing ethylene and a C₄-C₁₀ α-olefin comonomer in a second reactor in the presence of a second metallocene catalyst.

In an aspect of the present invention, the first metallocene catalyst and the second metallocene catalyst are the same as described above, and may further include a cocatalyst and a solvent.

In an aspect of the present invention, the operating conditions of the first reactor and the second reactor may be 80 to 250° C., and more specifically 120 to 220° C., and the pressure may be 20 to 500 atmospheres, and more specifically 30 to 200 atmospheres.

In addition, the raw materials injected in the polymerization step may be cooled or heated while undergoing a heat exchange process before being injected, whereby the temperature in the reactor may be controlled.

As illustrated in FIG. 1, the method for producing an ethylene polymer according to the present invention includes: performing polymerization by injecting ethylene (10) and C₄-C₁₀ alpha-olefin (20) as a first reaction raw material into a first reactor (100); performing polymerization by injecting a polymerization solution polymerized in the first reactor (100) and ethylene (30) and C₄-C₁₀ alpha-olefin (40) as a second reaction raw material into a second reactor; separating an ethylene polymer (400) and an unreacted material by transferring the polymerization solution polymerized in the second reactor (200) to a separation area (300); recycling unreacted alpha-olefin and unreacted ethylene by transferring the unreacted material to a recycle area (500); and re-injecting a recycle streams (510, 520) including the recycled unreacted alpha-olefin and unreacted ethylene into the first and second reactors, wherein a first Raman spectrometer (1) is located at a front end of the first reactor (100), a second Raman spectrometer (2) is located at a front end of the second reactor (200), a third Raman spectrometer (3) is located at a rear end of the first reactor (100), and a fourth Raman spectrometer (4) is located at a rear end of the second reactor (200), and the density of the ethylene polymer is predicted and controlled by quantitatively analyzing the content of unreacted alpha-olefin in the recycle streams (510, 520) in real time using the first Raman spectrometer (1) and the second Raman spectrometer (2), quantitatively analyzing the content of unreacted alpha-olefin and unreacted ethylene in a polymerization solution in real time using the third Raman spectrometer (3) and the fourth Raman spectrometer (4), and controlling in real time the amount of alpha-olefins (20, 40) injected as a reaction raw material to the first reactor (100) and the second reactor (200).

In an aspect, as described above, the first reactor and the second reactor may be separately provided, and the reactant of the first reactor and a new raw material may be injected into the second reactor to perform the reaction, thereby more precisely controlling the density and molecular weight of the final product.

In an aspect, when the recycle streams (510, 520) are re-injected into the first and second reactors, it is preferable to perform purification through purifiers (600, 700) to remove impurities that may be used as raw materials, that is, moisture, oxygen, carbon monoxide, and other metallic impurities that may potentially poison the catalyst.

In addition, in an aspect, It is possible to analyze the injected amount of alpha-olefins (20, 40) injected as a reaction raw material into the first reactor (100) and the second reactor (200) as well as the content of the ethylene (10, 30) and the unreacted material of the recycle streams (510, 520) by performing quantitative analysis in real time from the data obtained from the first to fourth Raman spectrometers using the controllers (800, 900), so that it is possible to control the amount of alpha-olefin to be injected as a raw material.

When quantitative analysis is performed in real time using the first to fourth Raman spectrometers, it is preferable to insert the Raman probe in situ, but the present invention is not limited thereto.

In an aspect, in order to quantitatively analyze in real time using the first to fourth Raman spectrometers, the method for producing an ethylene polymer may include: obtaining a regression model for determining a density of a polymer; obtaining Raman spectroscopy from the first to fourth Raman spectrometers; calculating scores of major components from the Raman spectroscopy; and calculating the density of the polymer by applying the scores of the main components to a regression model.

The obtaining of the regression model for determining a density of a polymer is not limited as it is possible by a conventional method, but in an aspect of the present invention, the reaction is performed by injecting a predetermined amount of raw material, but the reaction is performed while varying the amount of raw material injected for each reaction. Also, the obtaining of the regression model may include: collecting each sample at the point where the first to fourth Raman spectrometers are located, obtaining the content of alpha-olefin through gas chromatography (GC) and NMR analysis, and obtaining a plurality of spectra according to the injected amount of each raw material; obtaining a plurality of spectra using a Raman spectrometer at the same point, and obtaining a plurality of spectra according to the content of the alpha-olefin; and obtaining a density change regression model of the ethylene polymer according to the content of alpha-olefin from the obtained spectrum.

More specifically, the concentration of alpha-olefin is calculated through GC by taking a sample at a location where the first and second Raman spectrometers are installed. An alpha-olefin concentration model is obtained using the calculated alpha-olefin concentration data and Raman spectrum data. The concentration regression model program may use a GRAMS IQ manufactured by Thermo Fisher Scientific. In addition, the regression model may be obtained using a Partial Least Square (PLS) method in the GRAMS IQ program.

Monitoring may be possible by calculating the Raman spectrum data from the recycle stream and the rear end of the reactor as real time concentrations by using the concentration regression model program.

The alpha-olefin content in the polymer may be obtained by calculating the front/rear concentration of the reactor using Raman spectroscopy and the amounts of ethylene and alpha-olefin injected as raw materials.

In addition, the viscosity of the ethylene polymer at the rear end of the reactor is obtained by further adding a viscometer at the positions of the third and fourth Raman spectrometers, and the melt index (MI) value is calculated by correcting the viscosity with the reactor temperature and the concentration data of the ethylene polymer at the rear end of the reactor. Here, the concentration data of the ethylene polymer may be calculated using the reaction amount of alpha-olefin and ethylene obtained from a Raman spectrometer located at the front and rear ends of the reactor. The alpha-olefin content of the ethylene polymer and MI data are used and compared to actual density values to obtain a regression model.

More specifically, from the data of the samples measured by the first and second Raman spectrometers, a model for obtaining the content of 1-octene in the peak areas of 3030 to 2826 cm⁻¹ and 1665 to 1624 cm⁻¹ is prepared by using the PLS method, the content of alpha-olefin may be analyzed using Raman spectral data obtained through Raman spectroscopy in real time. From the data of the samples measured by the third and fourth Raman spectrometers, the content of 1-octene may be analyzed using the peaks of 3030 to 2826 cm⁻¹ and 1665 to 1624 cm⁻¹ and the content of the ethylene may be analyzed in the peak areas of 1630 to 1610 cm⁻¹ and 133 to 1325 cm⁻¹ by using the regression model obtained using the PLS method.

Next, the obtaining Raman spectroscopy from the first to fourth Raman spectroscopy will be described in more detail. Raman probes may be installed at the measurement points of the first to fourth Raman spectrometers, spectral data of 150 to 3425 cm⁻¹ may be acquired by using a laser source in the 785 nm wavelength band from each probe, and the content of alpha-olefin may be analyzed by selecting/analyzing the aforementioned wavelength region.

The next step is the calculating of the scores of major components from the Raman spectroscopy.

The next step is the calculating of the density of the polymer by applying the scores of the main components to a regression model. Here, a ratio of the reacted alpha-olefin may be to obtain the amount of alpha-olefin in the polymer by subtracting the amount of unreacted alpha-olefin at the rear end of the reactor from the sum of the amount of alpha-olefin in the recycle stream and the amount of the injected alpha-olefin as a raw material. The regression model obtains a density prediction model using the content of the alpha-olefin component and the MI values of the polymer. The regression model may control parameters of the regression model so that the error between the actual value and the predicted value may be minimized.

Next, the injected amount of the feed raw material is controlled so that the ethylene polymer having a desired density and MI is polymerized by controlling the reaction using the calculated density.

In an example, calculated polymer properties are compared to target polymer properties, and one or more reactor parameters are adjusted based on a deviation between the calculated polymer properties and the target polymer properties. The one or more reactor parameters may include amounts of monomers, comonomers, catalysts and cocatalysts; the operating temperature of the reactor, the ratio of comonomer(s) to monomer, and the ratio of hydrogen to monomer or comonomer; and other parameters that affect the selected polymer properties. For example, the selected polymer property is the density, and the content of alpha-olefin in the polymer can be known by calculating the amount of change in alpha-olefin at the front/rear end of the reactor using the concentration at the front and rear ends of the reactor and the amount of the injected alpha-olefin analyzed through Raman spectrum. The alpha-olefin content of the polymer and the MI are used to predict the density. The amount of the injected alpha-olefin is controlled until a predicted density value reaches a target value. If the predicted value is less than the target value, the alpha-olefin content in the polymer is decreased to increase the density by reducing the amount of the injected alpha-olefin, and conversely, the alpha-olefin content is increased to decrease the density by increasing the amount of the injected alpha-olefin.

For example, in the case of fluidized bed polymerization of olefins, hydrogen may serve as a chain transfer agent. In this way, the molecular weight of the polymer product may be controlled. In addition, the polymer melt flow rate, such as melt index (MI), may be changed by varying the concentration of hydrogen in the olefin polymerization reactor. The present invention may control the reactor to produce a polymer having a selected MI range. This is achieved by knowing the relationship between a hydrogen concentration and the MI of the polymer produced by a particular reactor and programming the target MI or MI range into the reactor control system processor. The viscosity is measured at the rear end of the reactor, a viscosity value is corrected with temperature and a concentration value of the polymer in solution using a Raman analyzer, and are calculated and monitored as MI values, and by comparing these data to the target MI range, the flow of hydrogen into the reactor vessel can be controlled such that the MI range of the polymer product remains within the target MI range.

In an aspect of the present invention, from the concentration of ethylene (C2) and alpha-olefin, for example, C8, measured from the first to fourth Raman spectrometers, the alpha olefin content and production of the ethylene polymer may be predicted using the following Equation. In the following Equation, the solution refers to a solvent, a raw material, and a whole solution of the polymer.

C2 reacted in first reactor=flow rate of C2 in first reactor−concentration of unreacted C2 at rear end of first reactor(measured in third spectrometer)×flow rate of solution in first reactor [Equation 1]

C8 reacted in first reactor=flow rate of C8 in first reactor+concentration of C8 in the first reactor recycle stream(measured in first spectrophotometer)×flow rate of recycle stream in first reactor−concentration of unreacted C2 at rear end of first reactor(measured in third spectroscopy)×flow rate of solution in first reactor [Equation 2]

Polymer production in first reactor=C2 reacted in first reactor+C8 reacted in first reactor [Equation 3]

Content of C8 in polymer at rear end of first reactor=C8 reacted in first reactor/polymer production in first reactor [Equation 4]

Polymer content in solution at the rear end of first reactor=polymer output in first reactor/flow rate of solution in first reactor [Equation 5]

C2 reacted in first reactor and second reactor=flow rate of C2 in first reactor+flow rate of C2 in second reactor−concentration of unreacted C2 at rear end of second reactor(fourth spectrometer)×(flow rate of solution in first reactor+flow rate of solution in second reactor) [Equation 6]

C8 reacted in first and second reactors=flow rate of C8 of first reactor+concentration of C8 in first reactor recycle stream(measured in first spectrophotometer)×flow rate of recycle stream in first reactor+flow rate of C8 in second reactor+concentration of C8 in second reactor return stream(measured in second spectrometer)×the flow rate of recycle stream in second reactor concentration of unreacted C8 at rear end in second reactor(measured in fourth spectrometer)×(flow rate of solution in first reactor+flow rate of solution in second reactor) [Equation 7]

Polymer production in first and second reactors=C2 reacted in first and second reactors+C8 reacted in first and second reactors [Equation 8]

Content of C8 in polymer at rear end of second reactor=C8 reacted in the first and second reactors/polymer production in first and second reactors [Equation 9]

Content of polymer in solution at the rear end of second reactor=polymer production in the first and second reactors/flow rate of solution in first reactor+flow rate of solution in second reactor) [Equation 10]

Those skilled in the art will recognize that other reactor component properties and other reactor parameters may be used. In a manner similar to that described above, the final polymer properties may be obtained by measuring reactor parameters in a controlled manner in response to data generated by a Raman analyzer.

### MODE FOR THE INVENTION

Hereinafter, the present invention will be described in more detail on the basis of Examples and Comparative Examples. However, the following Examples and Comparative Examples are only examples for describing the present invention in more detail, and the present invention is not limited by the following Examples and Comparative Examples.

Hereinafter, physical properties were measured as follows.

### 1) Density

The density was measured according to ASTM D 792.

### 2) Melt Index

The melt index was measured according to ASTM D 1238 at 190° C. and 2.16 kg.

### 3) GC Analysis Method

Each sample was taken at a point where the first and second Raman spectrometers were located, and spectra were obtained through gas chromatography (GC) analysis.

The measurement conditions are as follows:

Column type: HP-5 30 m×0.32 mm×0.25 μm

Column flow: 1 ml/min

Split ratio: 100

Inlet Temp: 250° C.

Detector Temp: 280° ° C.

### Examples

As illustrated in FIG. 1, the first reactor and the second reactor were connected in series to each other, a first ethylene polymer was prepared in a first reactor, the prepared first ethylene polymer and unreacted material were transferred to a second reactor, a second ethylene polymer was successively polymerized by additionally injecting a monomer for preparing the second ethylene polymer, methyl cyclohexane as a solvent, (t-butylamido)dimethyl(tetramethylcyclopentadienyl) silane titanium(IV) dimethyl as a catalyst, and trityl tetrakis (pentafluorophenyl) borate as a cocatalyst into a second reactor, and at the same time, an ethylene polymer mixture in which the first ethylene polymer and the second ethylene polymer were mixed was prepared.

The polymerization conditions and the octene content of the ethylene polymer are summarized in Table 1 below.

TABLE 1

| | | | |
|---|---|---|---|
| Example 1 | Example 2 | Example 3 | Example 4 |

First reactor

| | | | | |
|---|---|---|---|---|
| Amount of injected | 12.7 | 12.4 | 6.6 | 5.5 |
| ethylene (t/h) | | | | |
| Amount of injected | 3.3 | 0.6 | 2.6 | 4.6 |
| octene(t/h) | | | | |
| Flow rate of recycle | 89.6 | 93.7 | 47.4 | 41.9 |
| stream | | | | |
| Octene content (%) in | 2.2 | 6.5 | 24.1 | 26.4 |
| recycle stream | | | | |
| (measured in first | | | | |
| Raman spectroscopy) | | | | |
| Flow rate of total | 107 | 107.2 | 58.9 | 54.9 |
| solution (t/h) | | | | |
| Concentration of | 2.8 | 2.3 | 1.8 | 2.0 |
| unreacted ethylene (%) | | | | |
| (measured in third | | | | |
| Raman spectroscopy) | | | | |
| Concentration of | 2.3 | 3.1 | 18.0 | 22.0 |
| Unreacted | | | | |
| octene(measured in | | | | |
| third Raman spec- | | | | |
| troscopy) | | | | |
| Concentration of | 22.5 | 25.3 | 38.2 | 44.9 |
| polymer octene (%) | | | | |
| MI (g/10 min) | 0.45 | 0.56 | 0.3 | 0.34 |
| (measured value) | | | | |
| Density (g/cc) | 0.9004 | 0.8918 | 0.8654 | 0.8563 |
| (predicted value) | | | | |
| Density (g/cc) | 0.9009 | 0.8952 | 0.8647 | 0.8554 |
| (measured value) | | | | |

Second reactor

| | | | | |
|---|---|---|---|---|
| Amount of injected | 16.2 | 13.9 | 7.4 | 8.3 |
| ethylene (t/h) | | | | |
| Amount of injected | 0.01 | 4.22 | 2.42 | 2.3 |
| octene (t/h) | | | | |
| Flow rate of recycle | 73.8 | 64.28 | 39.8 | 66.4 |
| stream (t/h) | | | | |
| Octene content (%) in | 1.9 | 5.7 | 15.1 | 13.7 |
| recycle stream | | | | |
| (measured in second | | | | |
| Raman spectroscopy) | | | | |
| Flow rate of total | 91 | 83.3 | 52.1 | 54.9 |
| solution** (t/h) | | | | |
| Concentration of | 1.5 | 1.2 | 1.1 | 1.0 |
| Unreacted ethylene | | | | |
| (%)(measured in fourth | | | | |
| Raman spectroscopy) | | | | |
| Concentration of | 2.0 | 5.1 | 13.8 | 11.8 |
| Unreacted octane | | | | |
| (%)(measured in fourth | | | | |
| Raman spectroscopy) | | | | |
| Concentration of | 8.9 | 23.5 | 27.4 | 41.2 |
| polymer octene (%) | | | | |
| MI (g/10 min) | 1.13 | 1.06 | 1.02 | 0.57 |
| (measured value) | | | | |
| Density (g/cc) | 0.9140 | 0.9034 | 0.8678 | 0.8636 |
| (predicted value) | | | | |
| Density (g/cc) | 0.9157 | 0.9040 | 0.8674 | 0.8637 |
| (measured value) | | | | |

* Amount of octane in recycle stream + amount of injected raw octene
**Including the flow rate of the first reactor

The Raman spectrometer used the model name Rxn3™ manufactured KAISER OPTICAL SYSTEM, and as illustrated in FIG. 1, a total of four Raman spectrometers were arranged by placing one each in the recycle stream of the front end and the rear end of the first and second reactors. It was measured using a laser source with a wavelength of 785 nm and a spectrum measurement range of 150 to 3425 cm⁻¹.

The concentrations of ethylene and octene were monitored in real time by taking a sample at a location where the first and second Raman spectrometers are installed in advance, calculating the concentration of alpha-olefin through GC, and by analyzing the spectrum data measured in real time by the Raman spectrometer using a regression model program (GRAMS IQ) that obtains the alpha-olefin concentration model using the calculated alpha-olefin concentration data and Raman spectral data.

Then, the viscosity data at the rear end of the reactor was corrected with alpha olefin content, temperature, and concentration values of the polymer to calculate MI data. The density was predicted using the octene content ratio and the MI value of the reactor.

It was confirmed that in the method for producing an ethylene polymer according to an aspect of the present invention, the density of the ethylene polymer may be analyzed in real time, and the content of the injected raw material may be adjusted in real time to control the desired density, so that the productivity was further improved. Specifically, it was confirmed that the ethylene polymer of the desired density may be obtained by controlling the injected amount of the raw material while continuously polymerizing without waiting for an off-spec judgment of the product produced for 4 to 5 hours for analysis.

In addition, the main scores of the density and MI values obtained through the regression model while performing the reaction according to an aspect of the present invention are shown in Table 2 below. As shown in Table 2 below, it was found that a difference between the measured value and the predicted value was small.

TABLE 2

| | | Measured | | | Measured |
|---|---|---|---|---|---|
| Density | Density | value − | MI | MI | value − |
| (measured | (predicted | Predicted | (measured | (predicted | Predicted |
| value) | value) | value | value) | value) | value |
| 0.8559 | 0.8572 | −0.0013 | 0.200 | 0.191 | 0.009 |
| 0.8590 | 0.8578 | 0.0012 | 0.492 | 0.499 | −0.007 |
| 0.8634 | 0.8635 | −0.0001 | 0.510 | 0.516 | −0.006 |
| 0.8657 | 0.8657 | 0.0000 | 0.526 | 0.526 | 0.000 |
| 0.8673 | 0.8684 | −0.0011 | 0.980 | 0.919 | 0.061 |
| 0.8687 | 0.8699 | −0.0012 | 1.120 | 1.160 | −0.040 |
| 0.8706 | 0.8678 | 0.0028 | 2.890 | 2.934 | −0.044 |
| 0.8766 | 0.8815 | −0.0049 | 3.070 | 3.079 | −0.009 |
| 0.8798 | 0.8768 | 0.0030 | 3.470 | 3.038 | 0.432 |
| 0.8842 | 0.8854 | −0.0012 | 3.700 | 3.719 | −0.019 |
| 0.9004 | 0.9043 | −0.0039 | 4.510 | 5.077 | −0.567 |
| 0.9018 | 0.9045 | −0.0027 | 4.750 | 4.837 | −0.087 |
| 0.9039 | 0.9044 | −0.0005 | 4.890 | 4.848 | 0.042 |
| 0.9123 | 0.9163 | −0.0040 | 5.030 | 4.900 | 0.130 |
| 0.9141 | 0.9174 | −0.0033 | 5.180 | 5.087 | 0.093 |
| 0.9155 | 0.9136 | 0.0019 | 8.000 | 7.397 | 0.603 |
| 0.9170 | 0.9130 | 0.0040 | 13.400 | 13.559 | −0.159 |
| 0.9191 | 0.9207 | −0.0016 | 31.800 | 33.706 | −1.906 |

Hereinabove, although the present invention has been described by specific matters, the limited embodiments, and drawings, they have been provided only for assisting in a more general understanding of the present invention.

Therefore, the present invention is not limited to the exemplary embodiments. Various modifications and changes may be made by those skilled in the art to which the present invention pertains from this description.

Therefore, the spirit of the present invention should not be limited to the above-mentioned embodiments, but the claims and all of the modifications equal or equivalent to the claims are intended to fall within the scope and spirit of the present invention.

1. A method for producing an ethylene polymer, the method includes:
performing polymerization by injecting ethylene and C₄-C₁₀ alpha-olefin as a first reaction raw material into a first reactor;
performing polymerization by injecting a polymerization solution polymerized in the first reactor and ethylene and C₄-C₁₀ alpha-olefin as a second reaction raw material into a second reactor;
separating an ethylene polymer and an unreacted material by transferring the polymerization solution polymerized in the second reactor to a separation area;
recycling unreacted alpha-olefin and unreacted ethylene by transferring the unreacted material to a recycle area; and
re-injecting a recycle stream including the recycled unreacted alpha-olefin and unreacted ethylene into the first and second reactors,
wherein a first Raman spectrometer is located at a front end of the first reactor, a second Raman spectrometer is located at a front end of the second reactor, a third Raman spectrometer is located at a rear end of the first reactor, and a fourth Raman spectrometer is located at a rear end of the second reactor, and
the density of the ethylene polymer is predicted and controlled by quantitatively analyzing a content of unreacted alpha-olefin in the recycle stream in real time using the first Raman spectrometer and the second Raman spectrometer, quantitatively analyzing a content of unreacted alpha-olefin and unreacted ethylene in a polymerization solution in real time using the third Raman spectrometer and the fourth Raman spectrometer, and controlling in real time an amount of the injected alpha-olefin as a reaction raw material to the first reactor and the second reactor.

2. The method of claim 1, wherein a first reactor for producing a first ethylene polymer and the second reactor for producing a second ethylene polymer are connected in series or in parallel.

3. The method of claim 1, wherein when quantitative analysis is performed in real time using the first to fourth Raman spectrometers, a Raman probe is inserted in situ.

4. The method of claim 1, wherein when quantitative analysis is performed in real time using the first to fourth Raman spectrometers, the method includes:
obtaining a regression model for determining a density of a polymer;
obtaining Raman spectroscopy from the first to fourth Raman spectrometers;
calculating scores of major components from the Raman spectroscopy; and
calculating the density of the polymer by applying the scores of the main components to a regression model.

5. The method of claim 4, wherein the obtaining of the regression model includes:
obtaining a content of alpha-olefin through gas chromatography (GC) or NMR analysis by taking each sample at the point where the first to fourth Raman spectrometers are located, obtaining a plurality of spectra using a Raman spectrometer at the same point, and obtaining a plurality of spectra according to the content of the alpha-olefin; and
obtaining a density change regression model of the ethylene polymer according to the content of alpha-olefin from the obtained spectrum.

6. The method of claim 1, wherein the alpha-olefin is 1-octene.

7. The method of claim 6, wherein from data of the samples measured by the first and second Raman spectrometers, a content of 1-octene is analyzed in real time in peak areas of 3030 to 2826 cm⁻¹ and 1665 to 1624 cm⁻¹, and
from data of the samples measured by the third and fourth Raman spectrometers, a content of 1-octene is analyzed in peak areas of 3030 to 2826 cm⁻¹ and 1665 to 1624 cm⁻¹ and a content of ethylene is analyzed in peak areas of 1630 to 1610 cm⁻¹ and 1335 to 1325 cm⁻¹.

8. The method of claim 1, wherein the reaction raw material further includes a solvent and a catalyst.

9. The method of claim 1, wherein the ethylene polymer has a MI of 0.1 to 50 g/10 min measured at 190° C. and 2.16 kg according to ASTM D 1238.

10. The method of claim 9, wherein the ethylene polymer has a density of 0.85 to 0.95 g/cc.

11. The method of claim 1, wherein a melt index (MI) value is predicted and controlled by further adding a viscometer at the positions of the third and fourth Raman spectrometers.
